(19) United States
(12) Patent Application Publication
(10) Pub. No.: US 2012/0236355 A1
(43) Pub. Date: Sep. 20, 2012

(54) ELECTRONIC DEVICE, DATA PROCESSING SYSTEM, AND COMPUTER-READABLE RECORDING MEDIUM

(75) Inventor: Kensuke TANAKA, Kanagawa (JP)

(73) Assignee: RICOH COMPANY, LTD., Tokyo (JP)

(21) Appl. No.: 13/413,834

(22) Filed: Mar. 7, 2012

(30) Foreign Application Priority Data
Mar. 15, 2011 (JP) 2011-056236
Dec. 22, 2011 (JP) 2011-281573

(51) Int. Cl. G06K 15/02; G06F 3/12

(52) U.S. Cl. 358/1.14; 358/1.15

(57) ABSTRACT

An electronic device connected to at least another electronic device, the electronic device including a reception unit configured to receive an obtaining command, and an obtaining unit configured to obtain device data retained in at least one of the electronic device and the other electronic device. The device data includes log data indicating a process performed by at least one of the electronic device and the other electronic device, scan data indicating data scanned by at least one of the electronic device or the other electronic device, and setting data indicating data set to at least one of the electronic device and the other electronic device by a user. The device data obtained by the obtaining unit includes at least the scan data and the setting data.

### BACKGROUND OF THE INVENTION

1. Field of the Invention

The present invention relates to an electronic device, a data processing system, and a computer-readable recording medium.

2. Description of the Related Art

In a system having electronic devices such as servers and scanners connected thereto, each of the electronic devices has various log data stored therein. For example, Japanese Patent Laid-Open Patent Publication No. 2006-259811 proposes a technology of obtaining log data from each of the electronic devices in a batch in a case where an administrator of the system finds a problem in the system. Thereby, the administrator analyzes the problem by analyzing the obtained log data.

However, with the technology proposed in Japanese Patent Laid-Open Patent Publication No. 2006-259811, there may be a case where the problem cannot be sufficiently analyzed by merely analyzing the obtained log data. Such a case may result in the degrading of the efficiency of analyzing the problem.

### SUMMARY OF THE INVENTION

The present invention may provide an electronic device, a data processing system, and a computer-readable recording medium that substantially obviate one or more of the problems caused by the limitations and disadvantages of the related art.

Features and advantages of the present invention are set forth in the description which follows, and in part will become apparent from the description and the accompanying drawings, or may be learned by practice of the invention according to the teachings provided in the description. Objects as well as other features and advantages of the present invention will be realized and attained by an electronic device, a data processing system, and a computer-readable recording medium particularly pointed out in the specification in such full, clear, concise, and exact terms as to enable a person having ordinary skill in the art to practice the invention.

To achieve these and other advantages and in accordance with the purpose of the invention, as embodied and broadly described herein, an embodiment of the present invention provides an electronic device connected to at least another electronic device, the electronic device including: a reception unit configured to receive an obtaining command; and an obtaining unit configured to obtain device data retained in at least one of the electronic device and the other electronic device; wherein the device data includes log data indicating a process performed by at least one of the electronic device and the other electronic device, scan data indicating data scanned by at least one of the electronic device or the other electronic device, and setting data indicating data set to at least one of the electronic device and the other electronic device by a user; wherein the device data obtained by the obtaining unit includes at least the scan data and the setting data.

Other objects, features and advantages of the present invention will become more apparent from the following detailed description when read in conjunction with the accompanying drawings.

### BRIEF DESCRIPTION OF THE DRAWINGS

FIG. 1 is a schematic diagram illustrating an example of a functional configuration of a data processing system according to a first embodiment of the present invention;

FIG. 2 is a schematic diagram illustrating an example of a functional configuration of a primary electronic device and an example of a functional configuration of a subsidiary electronic device according to the first embodiment of the present invention;

FIG. 3 is a flowchart illustrating an operation performed in a case of obtaining device data with a primary electronic device according to the first embodiment of the present invention;

FIG. 4 is a schematic diagram illustrating an example of a button used in obtaining device data according to the first embodiment of the present invention;

FIG. 5 is a schematic diagram illustrating an example of an address data table indicating address data of each of subsidiary electronic device associated to a primary electronic device according to an embodiment of the present invention;

FIG. 6 is a schematic diagram illustrating an example of a screen of device data displayed by a displaying unit according to the first embodiment of the present invention;

FIG. 7 is a schematic diagram illustrating an example of a functional configuration of a data processing system according to a second embodiment of the present invention;

FIG. 8 is a schematic diagram illustrating an example of a screen for selecting electronic device groups according to an embodiment of the present invention;

FIG. 9 is a schematic diagram illustrating an example of a functional configuration of a primary electronic device and an example of a functional configuration of a subsidiary electronic device according to a modified example of the present invention;

FIG. 10 is a schematic diagram illustrating an example of a screen used for commanding a batch download of device data according to the modified example of the present invention;

FIG. 11 is a flowchart illustrating an operation performed in a case of obtaining device data with a primary electronic device according to the modified example of the present invention;

FIG. 12 is a schematic diagram illustrating an example of a format of an obtaining signal according to the modified example of the present invention;

FIG. 13 is a schematic diagram of a table illustrating a relationship between an error number of a detected error and an electronic device corresponding to the error number according to the modified example of the present invention; and

FIG. 14 is a schematic diagram illustrating a hardware configuration of a primary electronic device according to the modified example of the present invention.

### DETAILED DESCRIPTION OF THE PREFERRED EMBODIMENTS

### First Embodiment

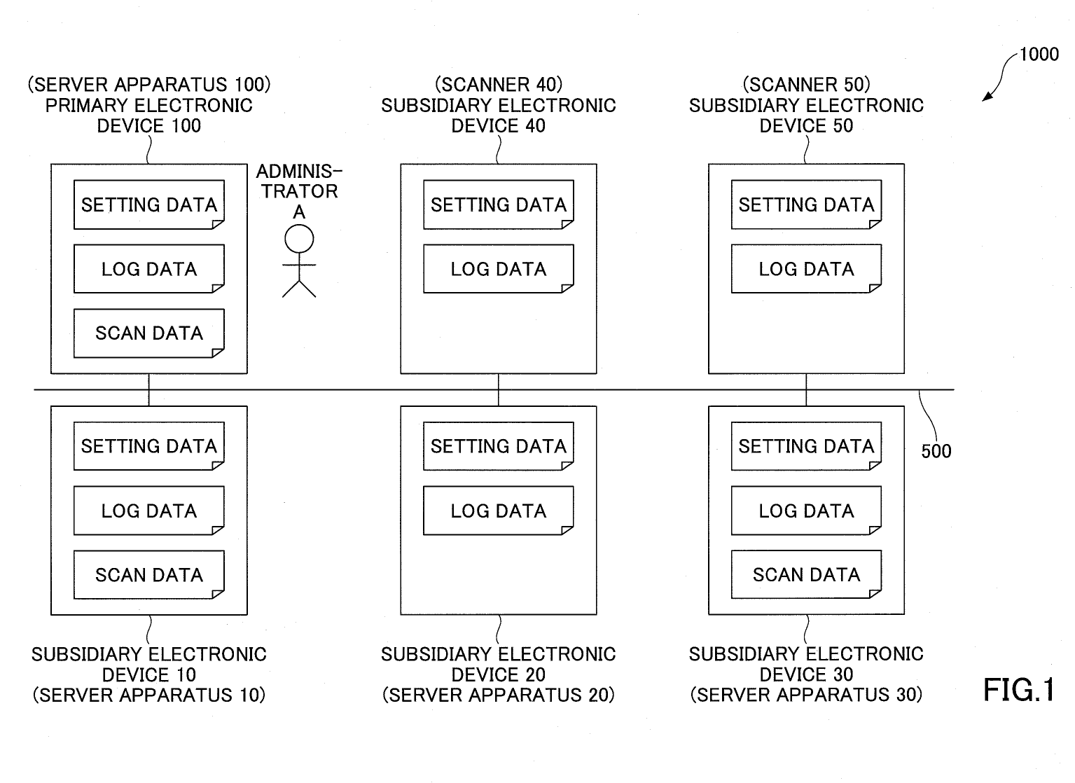

FIG. 1 illustrates an example of a functional configuration of a data processing system 1000 according to the first embodiment of the present invention. In the example of FIG. 1, the data processing system 1000 includes a primary electronic device 100 and five subsidiary electronic devices 10-50 that are connected to a network 500. In the following description, the subsidiary electronic devices 10-50 may also be collectively referred to as “subsidiary electronic device 60” for the sake of convenience.

The primary electronic device 100 is an electronic device connected to one or more of the subsidiary electronic devices 60.

The primary electronic device 100 is an electronic device on which problem analysis is performed by the administrator A. That is, the primary electronic device 100 is an electronic device to be managed by the administrator. Thus, the primary electronic device 100 may also be referred to as a “problem analysis target” or a “management target”. By operating the primary electronic device 100, the administrator can analyze a problem(s) occurring inside the data processing system 1000 including the primary electronic device 100. In the example of FIG. 1, the primary electronic device 100 is a server (server apparatus). Further, the subsidiary electronic devices 10-30 are also servers (server apparatuses). The subsidiary electronic devices 40 and 50 are scanners (scanner apparatuses).

Further, the administrator A obtains device data retained by the primary electronic device 100 and device data retained by the subsidiary electronic devices 10-40 that are associated to the primary electronic device 100. It is to be noted that, in this embodiment, the subsidiary electronic device 50 is not associated with the primary electronic device 100. By analyzing the obtained device data, the administrator A analyzes a problem(s) occurring in the data processing system 1000. In the first embodiment, the device data includes at least one of log data, setting data, and scan data. However, as described below, other data may be included in the device data if the data is useful for analyzing problems in the data processing system 1000.

The log data indicates the content of the processes performed in the past by the primary and the electronic devices 100, 10-50. Further, the setting data indicates settings (setting values) set beforehand by the user on the primary and the subsidiary electronic devices 100, 10-50. The setting data are described in further detail below. The scan data includes a scanned image(s). The scan data is generated by having the scanner 40 scan an original copy (manuscript) or the like.

In the example of FIG. 1, the primary electronic device 100 retains setting data, log data, and scan data. The subsidiary electronic device 10 also retains setting data, log data, and scan data. In the example of FIG. 1, it is to be noted that, although the subsidiary electronic devices 10, 30 retain scan data, the scan data retained by the subsidiary electronic devices 10, 30 is generated by the subsidiary electronic device 40 and transferred to the subsidiary electronic devices 10, 30.

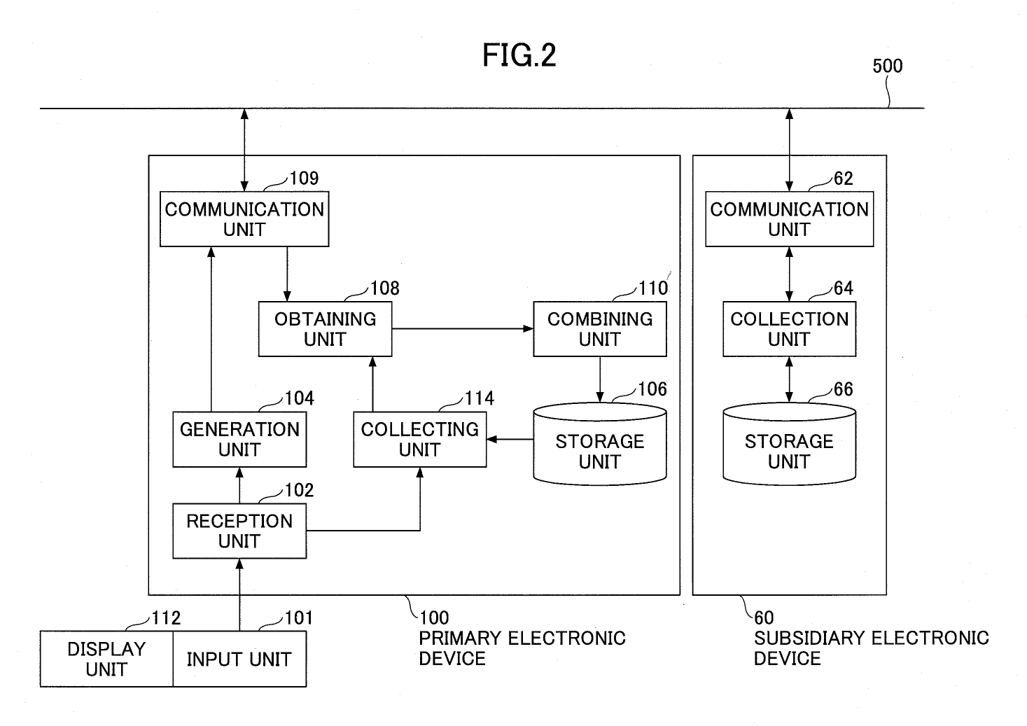

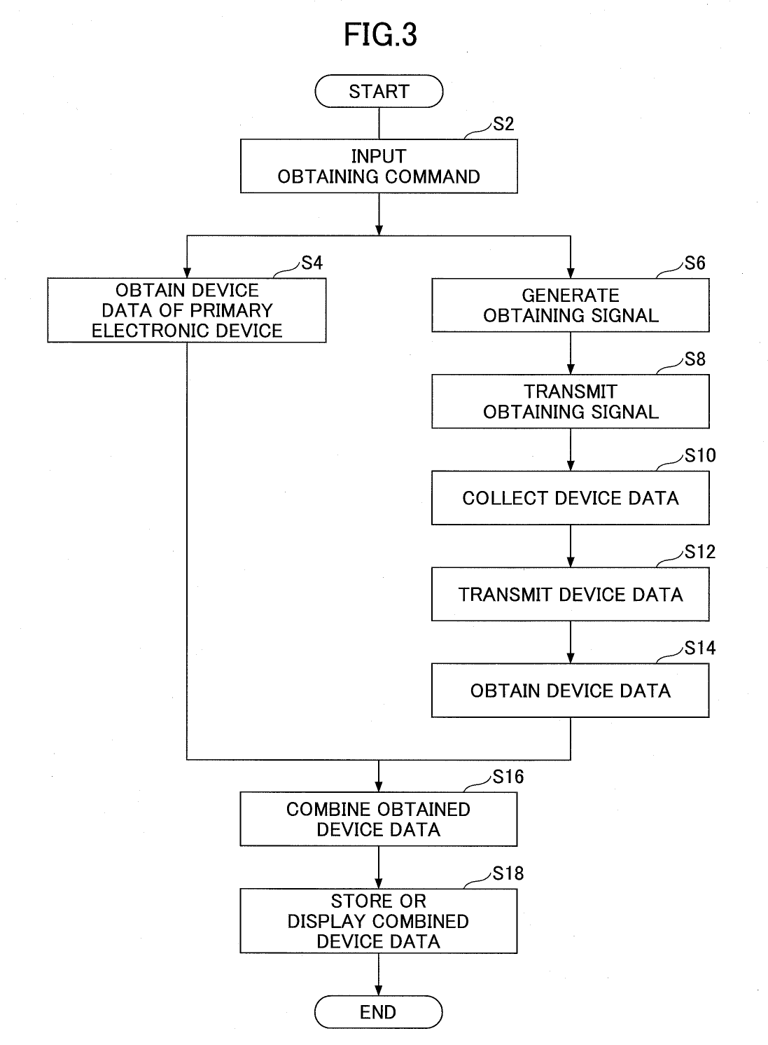

FIG. 2 illustrates an example of a functional configuration of the primary electronic device 100 and an example of a functional configuration of the subsidiary electronic device 60 according to the first embodiment of the present invention. Further, FIG. 3 is a flowchart illustrating an operation performed by the primary electronic device 100 according to the first embodiment of the present invention.

As illustrated in FIG. 2, the primary electronic device 100 includes, for example, a reception unit 102, a generation unit 104, a collecting unit 114, a communication unit 109, an obtaining unit 108, a combining unit 110, and a storage unit 106. The primary electronic device 100 may include or be connected to an input unit 101 and a display unit 112.

It is to be noted that the primary electronic device 100 is a server that provides functions for the data processing system 1000 to perform data processing and for enabling the administrator A to manage the data processing system 1000. Various known technologies may also be applied to provide the functions.

The subsidiary electronic device 60 includes a communication unit 62, a collecting unit 64, and a storage unit 66. As described above, the subsidiary electronic device 60 is a collective term for the servers 10-30 and the scanners 40, 50. More specifically, according to an embodiment of the present invention, the server 10 is a data distribution server, the server 20 is a print server 20, the server 30 is a load balance server, and the scanners 40, 50 are Multifunction peripherals (MFPs). For example, the data distribution server 10 distributes scan data generated by scanning an original copy with the scanner 40 to one or more predetermined client servers (not illustrated) via the network 500. The print server 20 outputs (prints out) the scan data generated by the scanner 40. In a case where the process load of the data distribution server 10 becomes too large, the load balance server 30 controls (instructs) the other servers (e.g., print server 20) to perform a portion of the processes to be performed by the data distribution server 10. Thereby, the large process load can be balanced between the data distribution server 10 and the print server 20. Various known technologies may also be applied to provide the functions of the subsidiary electronic device 60.

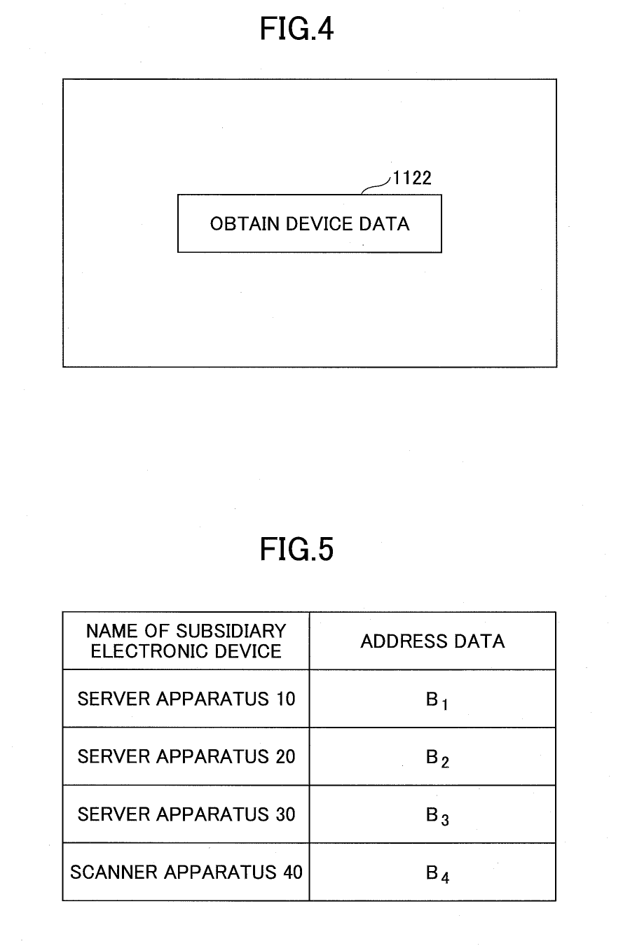

Next, an example of an operation performed in a case where the administrator A of the primary electronic device 100 inputs an obtaining command is described with reference to FIG. 3. First, the administrator A inputs an obtaining command to the primary electronic device 100 for obtaining device data by operating the input unit 101 provided outside of the primary electronic device 100 (Step S2). The input unit 101 may be, for example, a liquid crystal display (LCD) having a touch panel function (including software keys of a Graphical User Interface (GUI)) and/or a keyboard or mouse having a key switch (hardware key). More specifically, in accordance with the operation of the input unit 101 by the administrator A, the display unit 112 displays a button 1122 indicating “obtain device data” as illustrated in FIG. 4. Then, an obtaining command is input from the display unit 112 to the input unit 101 when the administrator A presses or clicks the button 1122.

The administrator A may input the obtaining command in predetermined periods, or whenever a problem is detected.

When the obtaining command is input to the input unit 101, the reception unit 102 receives the obtaining command from the input unit 101. The reception unit 102 transmits the received obtaining command to the generation unit 104 and the collecting unit 114. In accordance with the obtaining command from the reception unit 102, the collecting unit 114 collects device data retained by the primary electronic device 100.

In the example of FIG. 1, the collecting unit 114 collects device data including setting data, log data, and scan data retained in the primary electronic device 100. Then, the obtaining unit 108 obtains the device data collected by the collecting unit 114 (Step S4). The device data collected by the collecting unit 114 is stored in the storage unit 106. Therefore, the collecting unit 114 collects the device data from the storage unit 106.

On the other hand, the generation unit 104 generates an obtaining signal for obtaining device data from one or more subsidiary electronic devices 10-40 associated to the primary electronic device 100 in accordance with the obtaining command received from the reception unit 102 (Step S6).

In this embodiment, the generation unit 104 generates an obtaining signal in correspondence with each subsidiary electronic device 10-40 associated to the primary electronic device 100. It is to be noted that a “subsidiary electronic device associated to the primary electronic device” indicates a subsidiary electronic device that operates in association with any one of the processes performed by the primary electronic device. The storage unit 106 stores identification data for identifying each of the subsidiary electronic devices 10-40 associated to the primary electronic device 100. In this embodiment, the identification data for identifying the subsidiary electronic devices 10-40 are address data indicating the address of each of the subsidiary electronic devices 10-40 (e.g., IP address).

FIG. 5 is an example of an address data table indicating the address data of each of the subsidiary electronic devices 10-40 associated to the primary electronic device 100. In the address data table, addresses data B1-B4 are indicated in correspondence with the subsidiary electronic devices 10-40 (i.e. servers 10-30 and scanner 40). Because the subsidiary electronic device 50 is not associated to the primary electronic device 100, the address data of the subsidiary electronic device 50 is not included in the address data table of FIG. 5.

Then, the communication unit 109 transmits obtaining signals to corresponding addresses based on the address data B1-B4 indicated in the address data table (Step S8). In other words, the obtaining command is transmitted to the servers 10-30 and the scanner 40 by transmitting the obtaining signals to the servers 10-30 and the scanner 40 in Step S8.

Then, the communication unit 62 in each of the subsidiary electronic devices 10-40 receives the obtaining signal transmitted from the primary electronic device 100. In a case where the obtaining signal is received by the communication unit 62, the collecting unit 64 in each of the subsidiary electronic devices 10-40 collects the device data retained by each of the subsidiary electronic devices 10-40 (i.e. device data stored in the storage unit 66 of each of the subsidiary electronic devices 10-40) (Step S10).

Then, the communication unit 62 in each of the subsidiary electronic devices 10-40 transmits the device data collected by the collecting unit 64 to the primary electronic device 100 (Step S12). As illustrated in the example of FIG. 1, the device data retained by the subsidiary electronic device 10 includes setting data, log data, and scan data whereas the device data retained by the subsidiary electronic device 20 includes setting data and log data. The device data is transmitted by using, for example, HyperText Transfer Protocol (HTTP). Then, the communication unit 109 of the primary electronic device 100 obtains the device data transmitted from each of the subsidiary electronic devices 10-40 (Step S14).

The obtaining unit 108 waits (stands by) until the device data of all of the subsidiary electronic devices 10-40 associated to the primary electronic device 100 are obtained. The obtaining part 108 may determine whether the device data of all of the subsidiary electronic devices 10-40 associated to the primary electronic device 100 are obtained by referring to the address data table of FIG. 5 and determine whether device data is received from a corresponding address.

The combining unit 110 combines the device data obtained from the storage unit 106 of the primary electronic device 100 in Step S4 and the device data obtained from all of the subsidiary electronic devices 10-40 associated to the primary electronic device 100 in Step S14 (Step S16). The combined device data combined by the combining unit 110 may be stored in the storage unit 106 or displayed in the display unit 112.

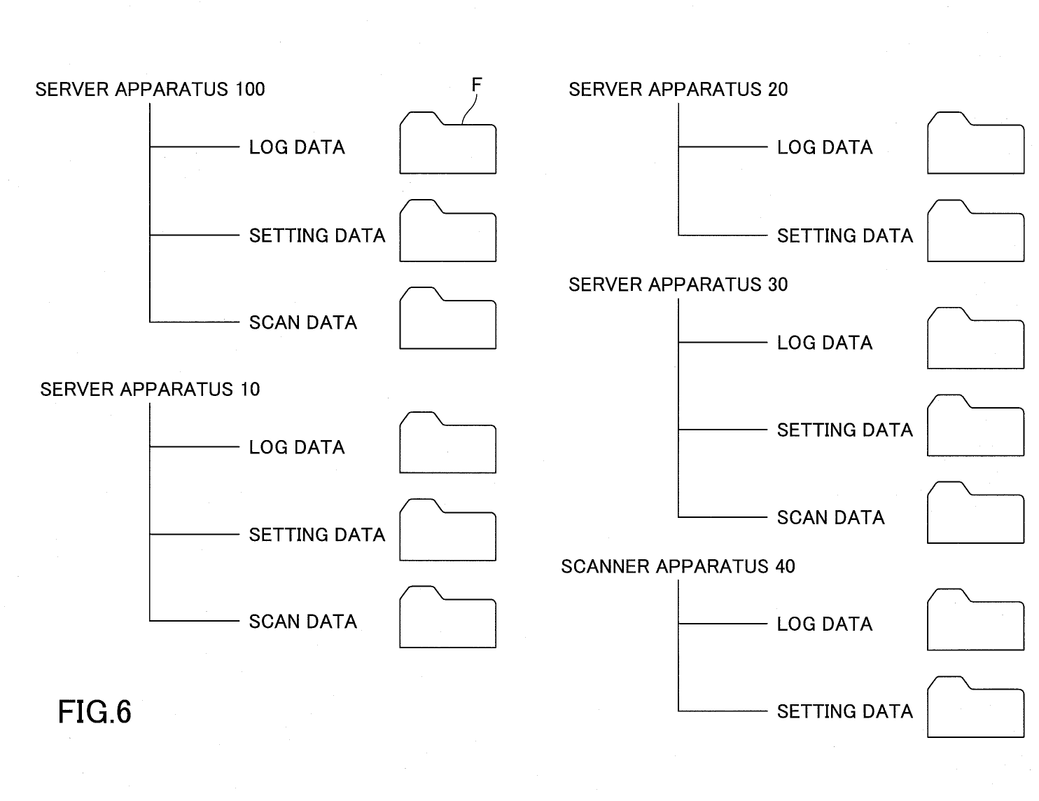

In this embodiment, combining device data means to create a state where the device data of all of the primary and subsidiary electronic devices 100, 10-40 can be handled in a batch by associating the device data of each of the primary and subsidiary electronic devices 100, 10-40. Thus, the device data of all of the primary and subsidiary electronic devices 100, 10-40 can be handled in a batch without requiring the user (e.g., administrator A) to designate the device data of each of the primary and subsidiary electronic devices 100, 10-40. Accordingly, as a result of combining the device data of the primary electronic device 100 and the device data of all of the subsidiary electronic devices 10-40 associated to the primary electronic device 100, the device data of the primary and subsidiary electronic devices 100, 10-40 can be designated by a single operation (maneuver). Therefore, in a case where the user desires to display all of the device data of the primary and subsidiary electronic devices 100, 10-40 as illustrated in FIG. 6, the user does not need to separately designate the device data of each of the primary and subsidiary electronic devices 100, 10-40.

In a case where the combined device data is stored in the storage unit 106, the administrator A can view the combined device data combined by the combining unit 110 by having the combined device data displayed on the display unit 112 at a desired time and analyze problems in the data processing system 1000. Alternatively, the combined device data combined by the combining unit 110 may be displayed on the display unit 112, so that the administrator A can immediately view the combined device data and analyze problems in the data processing system 1000.

FIG. 6 illustrates an example of a screen of device data displayed by the displaying unit 112 according to an embodiment of the present invention. The screen of FIG. 6 displays the folders F of log data, setting data, and scan data of the primary electronic device (server 100) and subsidiary electronic devices (servers 10-30, scanner 40) associated to the primary electronic device according to an embodiment of the present invention.

With the screen of FIG. 6, the folder of the device data desired to be viewed by the administrator A is clicked by the administrator A. The folder of log data contains, for example, log data files (log data) stored therein. The folder of setting data contains, for example, setting data files (setting data or setting values) stored therein. The folder of scan data contains, for example, scan data in formats such as Tagged Image File Format (TIFF) and Joint Photographic Experts Group (JPEG) (scan data or scan images). Thereby, the administrator A can view the device data of the primary electronic device 100 and the device data of the subsidiary electronic devices 10-40 associated to the primary electronic device 100 and analyze problems in the data processing system 1000.

By analyzing the log data of the primary and the subsidiary electronic devices 100, 10-40, the administrator A can analyze and track whether there are any problems in the history of the processes performed by the primary and the subsidiary electronic devices 100, 10-40 or problems in the content of the processes performed by the primary and the subsidiary electronic devices 100, 10-40. Further, by analyzing the setting data of the primary and the subsidiary electronic devices 100, 10-40, the administrator A can analyze whether there are any problems in the setting values set to the primary and the subsidiary electronic devices 100, 10-40. Further, by analyzing the scan data of the primary and the subsidiary electronic devices 100, 10-40, the administrator A can analyze whether there are any problems in the scanner associated to the primary electronic device 100 (in this example, scanner 40). In addition, by analyzing the scan data of the primary and the subsidiary electronic devices 100, 10-40, not only the problems in the scanner itself but also problems of the functions of the scanner (e.g., Optical Character Recognition (OCR) function, barcode recognition function) can be analyzed.

It is to be noted that the process for obtaining device data of the primary electronic device 100 (Step S4 of FIG. 3) and the process for obtaining device data of the subsidiary electronic devices 10-40 (Steps S6-S14 of FIG. 3) need not be performed in parallel but may also be performed one after the other.

As described above, the storage unit 106 of the primary electronic device 100 stores:

i) the device data of the primary electronic device 100,
ii) the address data of the subsidiary electronic device 60 associated to the primary electronic device 100 (see, for example, FIG. 5), and
iii) the device data of the primary electronic device 100 obtained from the storage unit 106 and the device data of the subsidiary electronic devices 10-40 obtained from the subsidiary electronic devices 10-40.

Alternatively, first, second, and third storage units may be provided for storing:

i) the device data of the primary electronic device 100,
ii) the address data of the subsidiary electronic device 60 associated to the primary electronic device 100 (see, for example, FIG. 5), and
iii) the device data of the primary electronic device 100 obtained from the storage unit 106 and the device data of the subsidiary electronic devices 10-40 obtained from the subsidiary electronic devices 10-40, respectively.

With the above-described first embodiment of the present invention, the administrator A can obtain the device data of the primary electronic device 100 and the device data of the subsidiary electronic devices 10-40 associated to the primary electronic device 100 simply by inputting an obtaining command once to the primary electronic device 100 (see, for example, Step S2 of FIG. 3). Thereby, the administrator A can efficiently analyze problems occurring in the data processing system 1000. Further, in a case where the administrator A recognizes a failure (malfunction) in the primary electronic device 100, the administrator A not only can obtain device data of the primary electronic device 100 but rather obtain the device data of the primary electronic device 100 and the device data of the subsidiary electronic devices 10-40 associated to the primary electronic device 100.

Further, in a case where the administrator A determines that the cause of the problem is in the primary electronic device 100 as a result of the analysis of the device data of the primary electronic device 100, it is possible that, in the future, a similar problem may occur in the subsidiary electronic devices 10-40 associated to the primary electronic device 100. Therefore, the administrator A may obtain device data not only from the primary electronic device 100 but also from the subsidiary electronic devices 10-40 associated to the primary electronic device 100, and analyze the subsidiary electronic devices 10-40. Thereby, problems, which are likely to occur in the future in the subsidiary electronic devices, can be detected by the administrator A beforehand.

In the above-described first embodiment of the present invention, address data of all of the subsidiary electronic devices 10-40 associated to the primary electronic device 100 are stored in the primary electronic device 100 (see, for example, FIG. 5). With the address data, the primary electronic device 100 transmits obtaining signals to the addresses indicated in the address data (see, for example, Step S8 of FIG. 3). Accordingly, even if the administrator A does not know the subsidiary electronic devices 10-40 associated to the primary electronic device 100, the device data of the subsidiary electronic devices 10-40 can be obtained.

### Second Embodiment

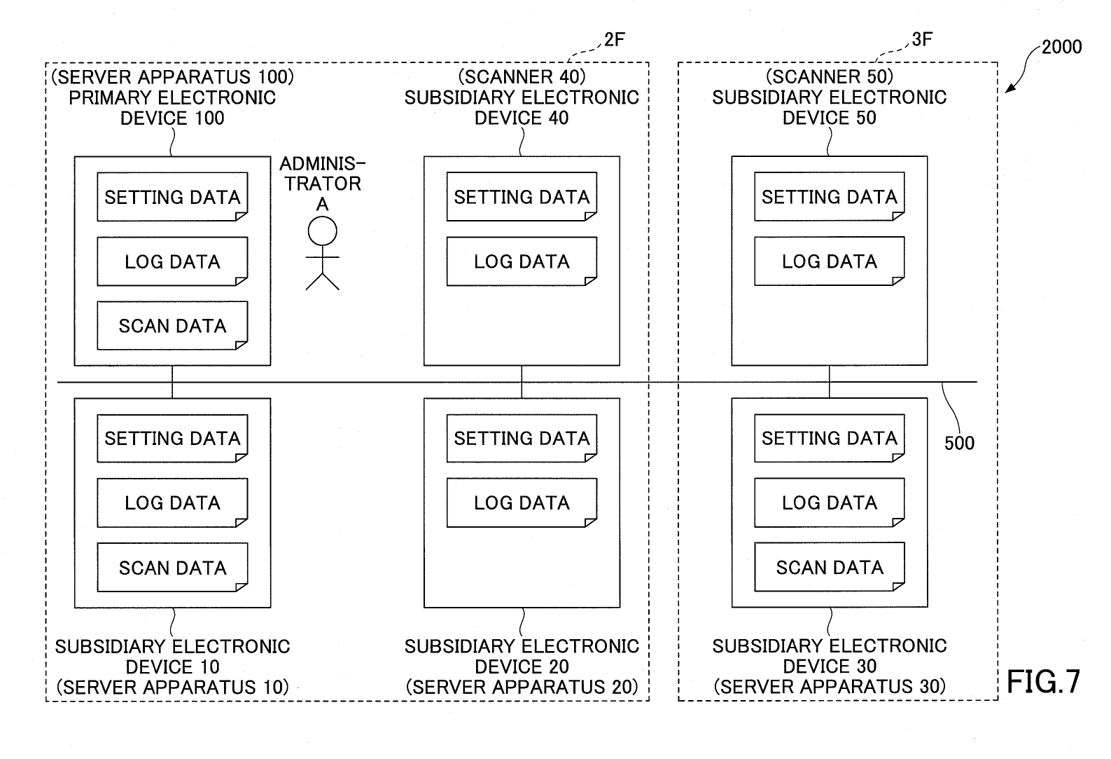

Next, a primary electronic device according to a second embodiment of the present invention is described. FIG. 7 illustrates an example of a functional configuration of a data processing system 2000 according to the second embodiment of the present invention. In the second embodiment, like components are denoted with like reference numerals as those of the first embodiment and are not explained in further detail. In the second embodiment, it is assumed that the subsidiary electronic devices 10-50 (also collectively referred to as subsidiary electronic device 60-1) are associated to the primary electronic device 100. In the data processing system 2000 of the second embodiment, the subsidiary electronic devices 10-50 are divided into groups.

With reference to the example of FIG. 7, in a case where the primary and the subsidiary electronic devices 100, 10-50 are provided in a building of a company, the primary and the subsidiary electronic devices 100, 10-50 are divided into plural groups based on the floor in which the primary and the subsidiary electronic devices 100, 10-50 are installed. In the example of FIG. 7, the primary electronic device 100 and the subsidiary electronic devices 10, 20, 40 are installed on the second floor (2F) of the building. It is assumed that the primary electronic device 100 and the subsidiary electronic devices 10, 20, 40 installed on the second floor constitute a first electronic device group. The subsidiary electronic devices 30, 50 are installed on the third floor (3F) of the building. It is assumed that the subsidiary electronic devices 30, 50 constitute a second electronic device group. The functional configuration of the primary and the subsidiary electronic devices 100, 60 (i.e. 10-50) of the second embodiment is substantially the same as the functional configuration illustrated in FIG. 2. Further, the operation performed by the primary electronic device 100 according to the second embodiment is substantially the same as the operation illustrated in the flowchart of FIG. 3.

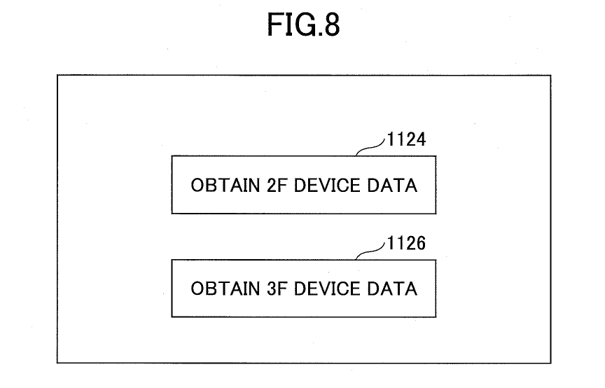

In the second embodiment, the administrator A operates the input unit 101 to select an electronic device group having the device data desired to be obtained. FIG. 8 illustrates an example of a screen for selecting the electronic device groups. In the example of FIG. 8, a button 1124 indicating “obtain 2F device data” and a button 1126 indicating “obtain 3F device data” are displayed on the screen in correspondence with the first electronic device group (including the primary and the subsidiary electronic devices 10, 20, 40) and the second electronic device group (including the subsidiary electronic devices 30, 50), respectively. The screen of FIG. 8 is displayed by the display unit 112.

The administrator A inputs an obtaining command by pressing the button 1124 or the button 1126 (Step S2 of FIG. 3). Accordingly, the device data stored in the storage unit 106 of the primary electronic device 100 is obtained (Step S4 of FIG. 3). Further, obtaining signals are generated and transmitted to the subsidiary electronic devices included in the electronic device group corresponding to the button (1124 or 1126) pressed by the administrator A (Step S6, S8 of FIG. 3).

For example, in a case where the administrator A presses the button “obtain 2F device data” 1124, the collecting unit 114 of the primary electronic device 100 collects device data from the storage unit 106 of the primary electronic device 100 (Step S4 of FIG. 3). Further, the communication unit 109 of the primary electronic device 100 generates obtaining signals corresponding to the subsidiary electronic devices 10, 20, 40 and transmits the obtaining signals to the corresponding subsidiary electronic devices 10, 20, 40 (Steps S6 and S8 of FIG. 3). Then, the communication unit 109 obtains the device data of the subsidiary electronic devices 10, 20, 40 installed on the second floor (Steps S10, S12, S14 of FIG. 3). The processes following Step S14 are the same as those of Steps S16 and S18 of FIG. 3.

In other words, even in a case where the electronic device group that does not include the primary electronic device 100 is selected by the input unit 101, the obtaining unit 108 obtains the device data retained in the primary electronic device 100 via the collecting unit 114. For example, in a case where the button “obtain 3F device data” 1126 is pressed, the primary electronic device 100 operates as follows. The communication unit 109 generates obtaining signals and transmits the obtaining signals to the subsidiary electronic devices 30, 50 included in the electronic device group corresponding to the button 1126 (Steps S6 and S8 of FIG. 3). In addition, the obtaining unit 108 obtains the device data stored in the storage unit 106 of the primary electronic device 100 (Step S4 of FIG. 3). Further, the obtaining unit 108 of the primary electronic device 100 obtains the device data from the other electronic devices installed on the third floor (i.e. subsidiary electronic devices 30 and 50) (Steps S10, S12, and S14 of FIG. 3). The processes following Step S14 are the same as those of Steps S16 and S18 of FIG. 3.

Accordingly, with the above-described second embodiment of the present invention, the administrator A can select an electronic device group including the device data to be obtained.

### Other Embodiments

Next, other embodiments of the present invention are described. In a case where device data is transmitted to the primary electronic device 100 from the subsidiary electronic device 60 associated to the primary electronic device 100 according to another embodiment of the present invention, the device data may be encoded. By encoding the device data, the device data can be safely transmitted to the primary electronic device 100.

In this case, the obtaining unit 108 of the primary electronic device 100 obtains encoded device data from the subsidiary electronic device 60 associated to the primary electronic device 100. Then, the encoded device data is decoded in the primary electronic device 100. Accordingly, the primary electronic device 100 may include a decoding unit (not illustrated) for decoding the encoded device data.

In a case where device data is transmitted to the primary electronic device 100 from the subsidiary electronic device 60 associated to the primary electronic device 100 according to another embodiment of the present invention, the device data may be compressed. By compressing the device data, the communication cost for transmitting the device data to the primary electronic device 100 can be reduced.

In this case, the obtaining unit 108 of the primary electronic device 100 obtains compressed device data from the subsidiary electronic device 60 associated to the primary electronic device 100. Then, the compressed device data is decompressed in the primary electronic device 100. Accordingly, the primary electronic device 100 may include a decompressing unit (not illustrated) for decompressing the compressed device data.

### Modified Example

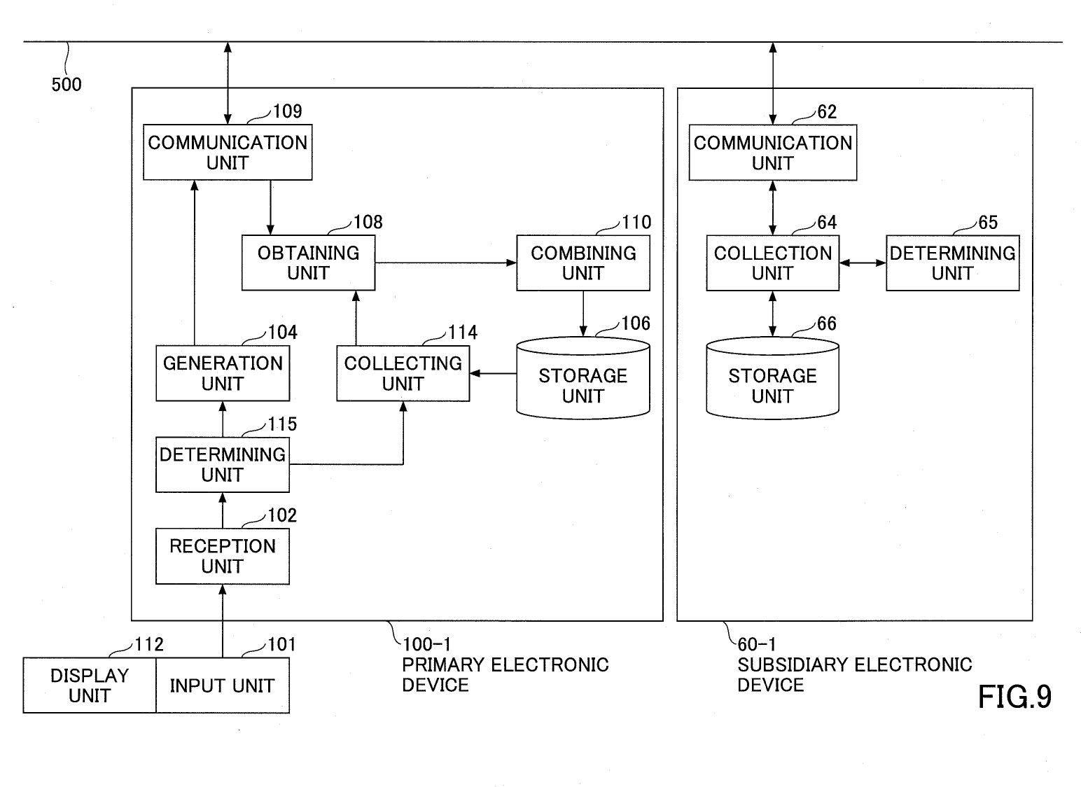

Next, a modified example of the first embodiment of the present invention is described with reference to FIGS. 9-13.

In the above-described first embodiment, the device data retained by the primary electronic device 100 and the device data retained by the subsidiary electronic devices 10-40 associated to the primary electronic device 100 are collected in a batch. However, in a case where there is an error in a job executed by one of the electronic devices, the collected device data may include device data of an electronic device having no relationship with the job and no significance for analyzing the cause of the error. In such a case, due to collecting the device data of the primary electronic device 100 and the device data of all of the subsidiary electronic devices 10-40, it may become necessary to extract the device data associated to the job from the collected device data. This may result in the degrading of the efficiency of analyzing the problem. In view of the above, the following modified example of the first embodiment (hereinafter also simply referred to as “modified example”) collects only the device data required for analyzing problems in the data processing system 1000.

FIG. 9 illustrates an example of a functional configuration of a primary electronic device 100-1 and an example of a functional configuration of a subsidiary electronic device 60-1 according to the modified example. Compared to the primary electronic device 100 of the first embodiment illustrated in FIG. 2, the primary electronic device 100-1 of the modified example includes a determining unit 115. Further, compared to the subsidiary electronic device 60 of the first embodiment illustrated in FIG. 2, the subsidiary electronic device 60-1 includes a determining unit 65.

Further, the data processing system including the primary and the subsidiary electronic devices 100-1, 60-1 of the modified example is substantially the same as the above-described data processing system 1000 illustrated in FIG. 1 except for the primary electronic device 100 being replaced by the primary electronic device of FIG. 9 and each of the subsidiary electronic devices 10, 20, 30, 40, and 50 being replaced by the subsidiary electronic device 60-1 of FIG. 9. Similar to the first embodiment, the subsidiary electronic devices 10, 20, 30, 40, 50 may be collectively referred to as the subsidiary electronic device 60-1. Further, the subsidiary electronic device 60-1 of the modified example is not limited to the subsidiary electronic devices 10, 20, 30, 40, 50 but may also include other subsidiary electronic devices.

In the modified example, the administrator A inputs data used for determining the electronic device including the device data to be obtained (hereinafter also referred to as “target electronic device”) and a condition(s) used for determining the range of the device data to be obtained from the target electronic device. It is to be noted that the data used for determining the target electronic device is also hereinafter referred to as “target electronic device determination data”, and the condition(s) used for determining the range of the device data to be obtained from the target electronic device is also hereinafter referred to as “target electronic device determination condition”.

The determination unit 115 of the primary electronic device 100-1 determines one or more of the target electronic device based on the target electronic device determination data input from the input unit 101 by the administrator A. In a case where the primary electronic device 100-1 is included in the one or more target electronic devices determined by the determination unit 115, the determination unit 115 determines the range of the device data to be obtained based on the target electronic device determination condition input from the input unit 101 by the administrator A. Then, the collecting unit 114 collects the device data in the range determined by the determining unit 115.

In a case where the subsidiary electronic device 60-1 is included in the one or more target electronic devices determined by the determining unit 115, the communication unit 109 transmits an obtaining signal including the input target electronic device determination condition to the one or more target electronic devices. Then, in a case where the one or more target electronic devices receives the obtaining signal, the determining unit 65 provided in each of the target electronic devices determines the range of the device data to be obtained based on the target electronic device determination condition included in the obtaining signal. Then, the collecting unit 64 provided in each of the target electronic devices collects the device data in the range determined by the determining unit 65. Then, the communication unit 62 provided in each of the target electronic devices transmits the collected device data to the primary electronic device 100-1.

The modified example is described above by using a case of obtaining device data of the primary electronic device 100-1 where the primary electronic device 100-1 is included in the one or more target electronic devices determined by the determining unit 115. However, in an alternative example, it is possible to allow the device data of the primary electronic device 100-1 to be obtained whenever the obtaining command is input regardless of whether the primary electronic device 100-1 is included in the one or more target electronic devices determined by the determining unit 115.

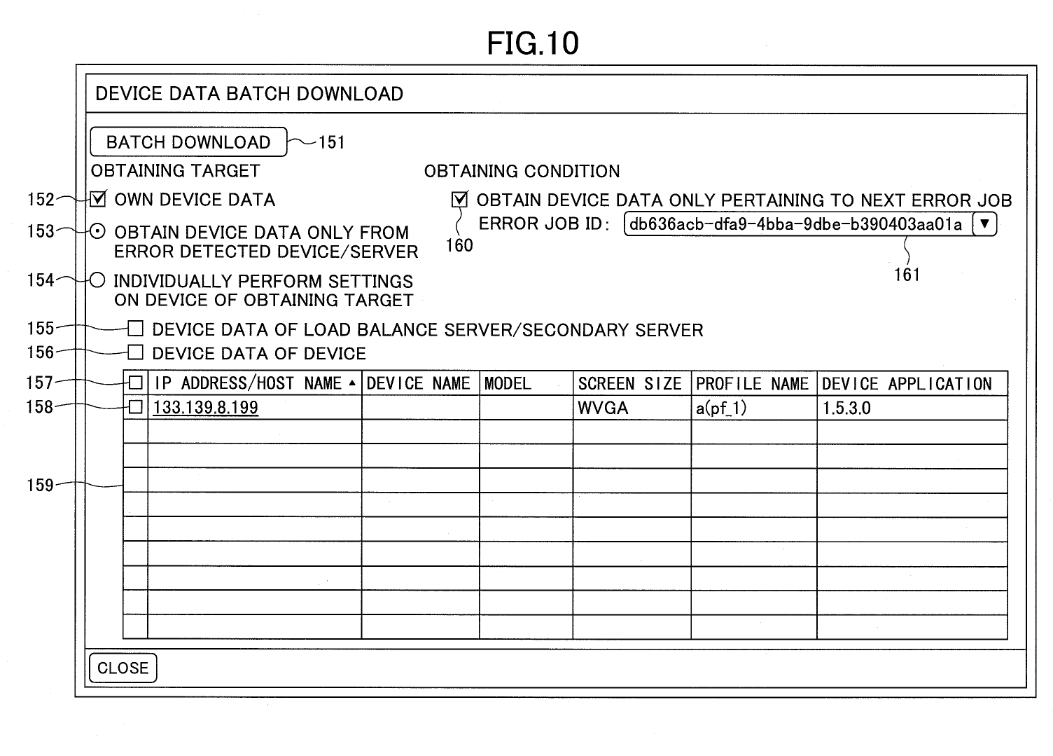

FIG. 10 illustrates an example of a screen used for commanding a batch download of device data (batch device data download screen) according to the modified example. The screen is displayed by the display unit 112 of the primary electronic device 100-1. The screen of FIG. 10 is displayed when the batch device data download is commanded from the input unit 101 by the administrator A. In this example, the batch device data download means to obtain device data in the range determined according to the target electronic device determination condition from the one or more target electronic devices determined according to the target electronic device determination data.

The operation of the batch device data download is initiated when the administrator A touches or clicks a switch 151 indicating “batch download” displayed in the screen of FIG. 10.

Accordingly, when a box 152 indicating “own device data” is ticked (checked) by the administrator A in a case where the switch “batch download” 151 is touched or clicked by the administrator A, device data of the primary electronic device 100-1 is obtained.

When a box 153 indicating “obtain device data only from error detected device/server” is ticked (checked) by the administrator A in a case where the switch “batch download” 151 is touched or clicked by the administrator A, device data is obtained from the electronic device which is determined as the origin of an error detected by the primary electronic device 100-1. In this case where the box “obtain device data only from error detected device/server” 153 is ticked by the administrator A, the target electronic device determination data includes data (error origin extraction command data) commanding to extract (identify) an electronic device from which the error is detected. In this case, the determining unit 115 extracts the electronic device from which the error is detected (origin of the error) based on the error origin extraction command data. Then, the device data of the extracted electronic device is obtained via, for example, the obtaining unit 108, the collecting unit 114, and the communication unit 109.

When a box 154 indicating “individually perform settings on device of obtaining target” and a box 155 indicating “device data of load balance server/secondary server” are ticked (checked) by the administrator A in a case where the switch “batch download” 151 is touched or clicked by the administrator A, the device data of a load balance server and a secondary server that are included in the subsidiary electronic device 60-1 are obtained. In the example of FIG. 1, the subsidiary electronic device 30 is a load balance server. The secondary server is not illustrated in FIG. 1.

When the box 154 indicating “individually perform settings on device of obtaining target”, a box 156 indicating “device data of device”, a box 157 indicating “IP Address/Host Name”, and a box 158 indicating an IP address such as “133.139.8.199” are ticked (checked) by the administrator A in a case where the switch “batch download” 151 is touched or clicked by the administrator A, the device data of the subsidiary electronic device 60-1 having an IP address “133.139.8.199” is obtained. It is to be noted that only the box 158 indicating “133.139.8.199” is illustrated in the column 159 “IP Address/Host Name” of the screen of FIG. 10 for the sake of convenience. In an actual screen, boxes indicating IP addresses and host names of all of the subordinate electronic devices 60-1 associated to the primary electronic device 100-1 are listed (displayed) in the column 159 “IP Address/Host Name” of the screen. Accordingly, the administrator A can obtain device data of a desired subsidiary electronic device 60-1 by ticking (checking) a corresponding box from the boxes indicating the IP addresses or the Host Names of the subsidiary electronic devices 60-1 associated to the primary electronic device 100-1.

When a box 160 indicating “obtain device data only pertaining to next error job” (i.e. obtain device data pertaining only to the next job from which an error is detected by the primary electronic device 100-1) is ticked (checked) by the administrator A and an error job identification data (ID) (i.e. identification data of the job from which an error is detected) indicating “db636acb- . . . -b390403aa01a” is displayed in a column “error job ID” 161 of the screen in a case where the switch “batch download” 151 is touched or clicked by the administrator A, only the device data pertaining to the job of the primary and/or the subsidiary electronic devices 100-1, 60-1 designated by the boxes 152-158 is obtained. In this example, the column “error job ID” 161 is displayed as a pull-down type menu. Therefore, in a case where there are plural jobs from which errors are detected by the primary electronic device 100-1, the administrator A selects a given error job listed in the pull-down type menu displayed in the column “error job ID” 161.

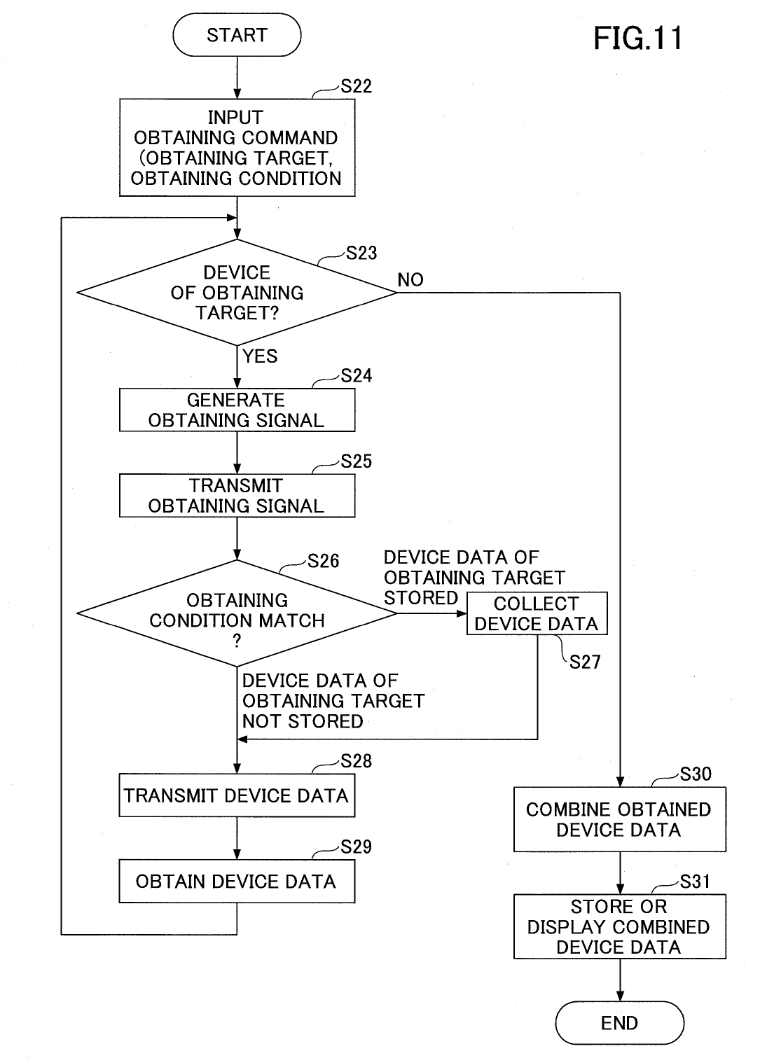

Next, an operation of obtaining and displaying device data with the primary electronic device 100-1 according to the modified example is described with reference to FIG. 11.

The administrator A inputs an obtaining command with the input unit 101 of the primary electronic device 100-1 together with using, for example, the batch device data download screen of FIG. 10 (Step S22). The obtaining command includes the above-described target electronic device determination data and target electronic device determination condition. The target electronic device determination data is data input by the administrator A by using, for example, the boxes 152-158 displayed on the batch device data download screen of FIG. 10. Similarly, the target electronic device determination condition is data input by the administrator A by using, for example, the box 160 or the “error job ID” column 161 displayed on the batch device data download screen of FIG. 10.

After the reception unit 102 receives the obtaining command input from the input unit 101, the obtaining command is transmitted to the determining unit 115. The determining unit 115 determines one or more electronic devices from which device data is to be obtained based on the target electronic device determination data included in the transmitted obtaining command. In Step S23, the determining unit 115 sequentially extracts one electronic device at a time from the one or more electronic devices from which device data is to be obtained and performs the processes of Steps S24-S29 on the extracted electronic device.

More specifically, in Step S23, the determining unit 115 determines whether there are any electronic devices that have not yet been extracted and subjected to the processes of Steps S24-S29. In other words, in a case where the processes of Steps S24-S29 are performed on all of the one or more electronic devices determined by the determining unit 115, the operation proceeds to Step S30 (No in Step S23). In a case where an electronic device that have not yet been extracted and subjected to the processes of Steps S24-S29 is remaining, the operation proceeds to Step S24 (Yes in Step S23), so that the processes of Steps S24-S29 are performed on the remaining electronic device.

In a case where the primary electronic device itself 100-1 is included in the one or more electronic devices and extracted from the one or more electronic devices, the operation proceeds to Step S26 without the processes of Steps S24 and S25 being performed.

The determining unit 115 transmits the received obtaining command (including the target electronic device determination condition) to the collecting unit 114. The collecting unit 114 refers to the target electronic device determination condition and determines whether there is device data matching the target electronic device determination condition stored in the storage unit 106. In a case where no matching device data is stored in the storage unit 106 (i.e. device data of obtaining target not stored), the operation proceeds to Step S28. In a case where matching device data is stored in the storage unit 106 (i.e. device data of obtaining target stored), the operation proceeds to Step S27. In Step S27, the collecting unit 114 collects the device data matching the target electronic device determination condition and proceeds to Step S28.

In a case of obtaining device data of the primary electronic device itself 100-1, the operation proceeds to Step S29 without the process of Step S28 being performed. In Step S29, the obtaining unit 108 obtains device data collected from the collecting unit 114. Then, the operation returns to Step S23. After returning to Step S23, it is determined whether an electronic device that have not yet been extracted and subjected to the processes of Steps S24-S29 is remaining. In a case where there is an electronic device remaining, the process of Steps S24-S29 are repeated with respect to the remaining electronic device.

On the other hand, in a case of obtaining device data of the subsidiary electronic device 60-1 where the subsidiary electronic device 60-1 is included in the one or more electronic devices and extracted from the one or more electronic devices, the determining unit 115 transmits the received obtaining command (including the target electronic device determination condition) to the generation unit 104. In Step S24, the generation unit 104 generates an obtaining signal including the target electronic device determination condition corresponding to the subsidiary electronic device extracted from one or more electronic devices. Then, in Step S25, the communication unit 109 transmits the generated obtaining signal to the subsidiary electronic device 60-1.

The communication unit 62 of the subsidiary electronic device 60-1 receives the obtaining signal transmitted from the communication unit 109. The determining unit 65 receives the obtaining signal from the collecting unit 114 via the communication unit 62 and determines whether there is device data matching the target electronic device determination condition stored in the storage unit 66 (Step S26). In a case where no matching device data is stored in the storage unit 66 (i.e. device data of obtaining target not stored in the storage unit 66), the operation proceeds to Step S28. In a case where matching device data is stored in the storage unit 66 (i.e. device data of obtaining target stored in the storage unit 66), the operation proceeds to Step S27. In Step S27, the collecting unit 64 collects the device data matching the target electronic device determination condition and proceeds to Step S28.

In a case of obtaining device data of the subsidiary electronic device 60-1, the communication unit 62 transmits the device data collected by the collecting unit 64 to the primary electronic device 100-1 in Step S28. Then, in Step S29, the communication unit 109 of the primary electronic device 109 receives the device data transmitted from the communication unit 62 and transmits the received device data to the obtaining unit 108. After the obtaining unit 108 receives the device data, the operation returns to Step S23. After returning to Step S23, it is determined whether an electronic device that have not yet been extracted and subjected to the processes of Steps S24-S29 is remaining. In a case where there is an electronic device remaining, the process of Steps S24-S29 are repeated with respect to the remaining electronic device.

Because the processes performed in Steps S30 and S31 are substantially the same as those performed in Steps S16 and S18, further description of the processes of Steps S30 and S31 is omitted.

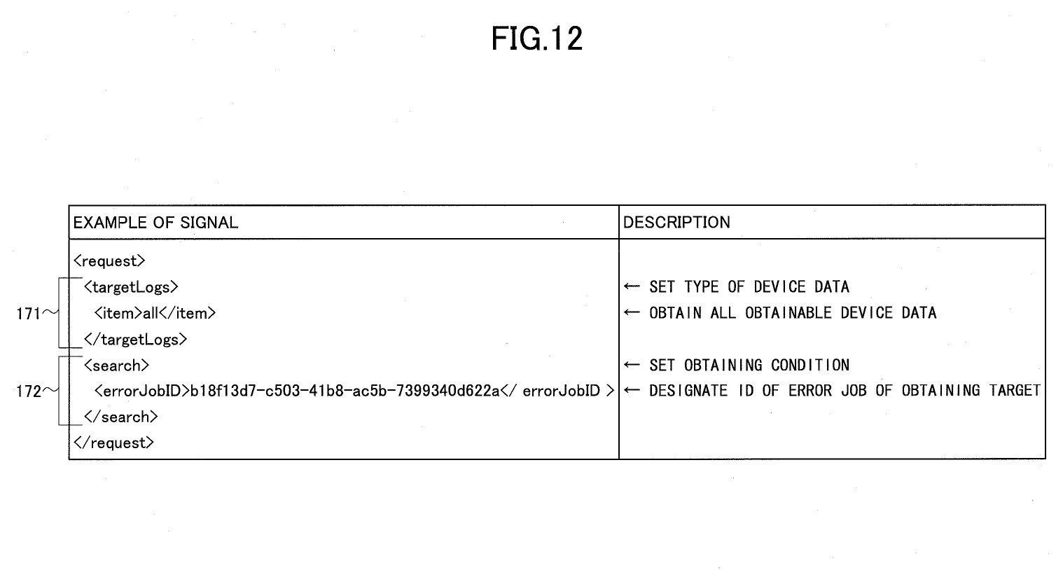

FIG. 12 is a schematic diagram illustrating an example of target electronic device determination conditions included in an obtaining signal generated in Step S24 of FIG. 11 according to an embodiment of the present invention. The target electronic device determination conditions illustrated in FIG. 12 include a device data type designating data 171 and error job identification data 172.

The device data type designating data 171 is data used in designating the type of device data to be obtained. The type of device data to be obtained may be, for example, at least one of log data, scan data, and setting data. In the example of FIG. 12, the device data type designating data 171 is indicated as “all” which means that all obtainable device data are to be obtained. In other words, in the example of FIG. 12, the device data type designating data 171 designates all log data, scan data, and setting data. It is to be noted that an item for designating the device data type designating data 171 is not included in the items displayed in the batch device data download screen of FIG. 10. Thus, in the example of FIG. 12, device data type designating data 171 indicating that all log data, scan data, and setting data be obtained may be automatically included in the obtaining signal. In an alternative example, an item for designating the device data type designating data 171 may be added to the items displayed in the batch device data download screen of FIG. 10 such as a pull-down type menu of a column displayed in the batch device data download screen of FIG. 10.

The error job identification data 172 is data used in identifying a job associated to an error (i.e. data for identifying a job from which an error is detected). In the example of FIG. 12, the error job identification data is “b18f13d7- . . . -7399340d622a”. The error job identification data 172 is included in a pull-down type menu of the column “error job ID” 161 displayed in the batch device data download screen of FIG. 10, so that the error job identification data 172 can be designated by the administrator A.

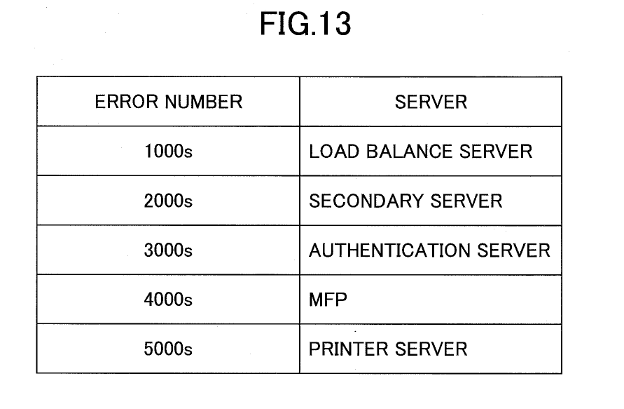

FIG. 13 is a table illustrating a relationship between an error number of a detected error and an electronic device corresponding to the error number according to an embodiment of the present invention. In a case where the primary electronic device 100-1 detects an error, the table is used for determining the electronic device (e.g., server) from which the error originates. For example, in a case where the administrator A checks (ticks) the box “obtain device data only from error detected device/server” 153 of the batch device data download screen of FIG. 10, the determining unit 115 of the primary electronic device 100-1 refers to the table. Then, the determining unit 115 searches the table by using an error number corresponding to the detected error as a key for the search. Accordingly, the determining unit 115 determines the electronic device (e.g., server) from which the detected error originates. In a case where the primary electronic device 100-1 detects an error, the error number of the detected error is stored as log data in, for example, the storage unit 106 of the primary electronic device 100-1. Then, the determining unit 115 obtains the error number of the detected error by referring to the log data.

Next, setting data of the primary and the subsidiary electronic devices 100-1, 60-1 is described. As described above, the setting data indicates settings (setting values) set beforehand on the primary and the subsidiary electronic devices 100, 100-1, 60, 60-1 by the user. For example, the setting data of the scanner 40 may be destination data of scan data (i.e. data of the destination to which scan data is transmitted). More specifically, the destination data may be data indicating an IP address of a server at the destination of the scan data (IP address data) or data indicating a workflow to be executed by the device at the destination of the scan data (e.g., scanned image) (workflow data). More specifically, the workflow data indicates the content of a process and the order of the process to be executed by the device at the destination of the scan data. The destination data may also include address data listed in an address table.

For example, in a case where an authenticating device is installed in the scanner 40, the setting data of the scanner 40 may also include data indicating an IP address of the authentication device or data indicating authentication parameters (e.g., user ID) used in authentication by an authentication server.

The device data to be obtained from the primary and the subsidiary electronic devices 100, 100-1, 60, 60-1 according to the above-described first and second embodiments and the modified example of the present invention includes log data, scan data, and setting data. However, the device data to be obtained from the primary and the subsidiary electronic devices 100, 100-1, 60, 60-1 is not limited to log data, scan data, and setting data. For example, the device data to be obtained from the primary and the subsidiary electronic devices 100, 100-1, 60, 60-1 may also include data indicating basic software such as the Operating System (OS) of each of the primary and the subsidiary electronic devices 100, 100-1, 60, 60-1.

### [Hardware Configuration of Primary Electronic Device]

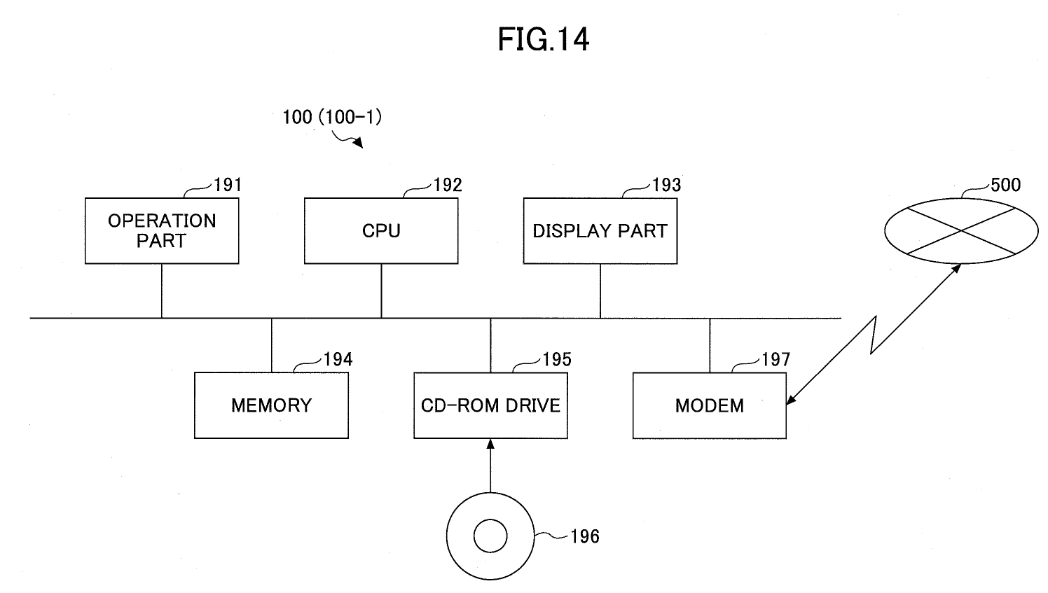

Next, an example of a hardware configuration of the primary electronic device 100 or 100-1 according to the above-described first and second embodiments and the modified example of the present invention is described with reference to FIG. 14. In the example of FIG. 14, the primary electronic device 100, 100-1 is a computer. It is to be noted that the subsidiary electronic device 60, 60-1 may also be a computer having substantially the same configuration as the primary electronic device 100, 100-1. However, in a case where the subsidiary electronic device 60, 60-1 has, for example, a printer function, a facsimile function, and/or a scanner function, the subsidiary electronic device 60, 60-1 not only includes a configuration of a computer but also a configuration of a hardware device (not illustrated) that provides the printer function, the facsimile function, and/or the scanner function.

As illustrated in FIG. 14, the primary electronic device 100 (100-1) includes a CPU 192 that controls and calculates the operations/processes of the entire primary electronic device 100 (100-1). Further, the primary electronic device 100 (100-1) includes an operation part 191 for enabling the administrator A to operate and input data to the primary electronic device 100 (100-1) and a display part 193 for displaying calculation results of the CPU 192 to the administrator A. Further, the primary electronic device 100 (100-1) includes a memory 194 in which programs executed by the CPU 192 and various data used by the CPU 192 are stored. Further, the primary electronic device 100 (100-1) includes a drive (in this example, a disk drive) 195 for installing various programs and data recorded in a computer-readable recording medium 196 such as a Compact Disc Read Only Memory (CD-ROM). Further, the primary electronic device 100 (100-1) includes a modem 197 for connecting and communicating to the network 500.

### [Program and Computer-Readable Recording Medium]

Next, an example of the computer-readable recording medium 196 and a program recorded in the program are described. The computer-readable recording medium 196 according to the above-described first and second embodiments and the modified example of the present invention may be, for example, a magnetic recording device, an optical disk, a magneto-optic recording disk, and a semiconductor memory. More specifically, the magnetic recording device may be, for example, a hard disk apparatus, a flexible disk, or a magnetic tape. The optical disk may be, for example, a Digital Versatile Disc (DVD), a Digital Versatile Disc Random Access Memory (DVD-RAM), a Compact Disc Read Only Memory (CD-ROM), a CD-Compact Disc Recordable/Rewritable (CD-R/RW). The magneto-optic recording disk may be, for example, a Magneto-Optical disc (MO). The semiconductor memory may be, for example, an (Electronically Erasable and Programmable-Read Only Memory (EEP-ROM).

The distribution of the program according to the above-described first and second embodiments and the modified example of the present invention may be distributed by selling, assigning, or lending the computer-readable recording medium 196 on which the program is recorded. In a case where the primary electronic device 100 (100-1) is a computer as illustrated in FIG. 14, the program is directly read out from the computer-readable recording medium 196. Then, the CPU 192 uses the memory 194 and executes the various processes of the program. It is to be noted that the program may include data used for the processes performed by CPU 192 (e.g., data which regulates the processes performed by the CPU 192 but does not directly command the computer). By executing the program with the CPU 192 of the computer illustrated in FIG. 14, all or a part of the processes of the primary electronic device 100, 100-1 can be performed with the above-described hardware configuration.

The present invention is not limited to the specifically disclosed embodiments, and variations and modifications may be made without departing from the scope of the present invention.

The present application is based on Japanese Priority Application Nos. 2011-056236 and 2011-281573 filed on Mar. 15, 2011 and Dec. 22, 2011, respectively, the entire contents of which are hereby incorporated herein by reference.

What is claimed is:

1. An electronic device connected to at least another electronic device, the electronic device comprising:
a reception unit configured to receive an obtaining command; and
an obtaining unit configured to obtain device data retained in at least one of the electronic device and the other electronic device;
wherein the device data includes log data indicating a process performed by at least one of the electronic device and the other electronic device, scan data indicating data scanned by at least one of the electronic device or the other electronic device, and setting data indicating data set to at least one of the electronic device and the other electronic device by a user;
wherein the device data obtained by the obtaining unit includes at least the scan data and the setting data.

2. The electronic device as claimed in claim 1, further comprising:
an input unit to which the obtaining command is input;
wherein the obtaining command includes a target electronic device determination data used for determining at least one of the electronic device and the other electronic device as a target electronic device from which the device data is to be obtained by the obtaining unit;
wherein the obtaining command includes a target electronic device determination condition used for determining the range of the device data to be obtained from the target electronic device.

3. The electronic device as claimed in claim 2, further comprising:
a determining unit configured to determine the target electronic device based on the target electronic device determination data;
wherein the obtaining unit is configured to obtain device data that matches the target electronic device determination condition from the target electronic device.

4. The electronic device as claimed in claim 3, further comprising: a communication unit for transmitting an obtaining signal including the target electronic device determination condition;
wherein the target electronic device determination data includes an error origin extraction command data used for commanding to extract the electronic device or the other electronic device from which an error is detected;
wherein the determining unit is configured to extract the electronic device or the other electronic device from which the error is detected when receiving the error origin extraction command data;
wherein in a case where the error is detected from the other electronic device, the communication unit is configured to transmit the obtaining signal to the other electronic device.

5. The electronic device as claimed in claim 4, further comprising:
a storage unit configured to store a table including data indicating an error number of the error and data indicating the electronic device or the other electronic device from which the error is detected;
wherein in a case where the determining unit receives the error origin extraction command data, the determining unit is configured to extract the electronic device or the other electronic device from the table by referring to the error number of the detected error;
wherein in a case where the other electronic device is extracted by the determining unit, the communication unit is configured to transmit the obtaining signal to the other electronic device.

6. The electronic device as claimed in claim 4, wherein the target electronic device determination condition includes an error job identification data indicating identification data of a job from which the error is detected;
wherein in a case where the error is detected from the other electronic device, the other electronic device obtains device data associated to the job from which the error is detected and transmits the device data associated to the job to the electronic device.

7. The electronic device as claimed in claim 2, wherein the target electronic device determination condition includes device type designating data that designates at least one of the log data, the scan data, and the setting data;
wherein the target electronic device is configured to extract at least one of the log data, the scan data, and the setting data in accordance with the device type designating data.

8. The electronic device as claimed in claim 1, wherein the obtaining unit is configured to obtain all of the device data retained in the electronic device and the other electronic device.

9. The electronic device as claimed in claim 1, wherein the obtaining unit is configured to obtain data pertaining to basic software of the target electronic device.

10. The electronic device as claimed in claim 5, wherein the storage unit is further configured to store identification data for identifying the other electronic device;
wherein the obtaining unit is configured to obtain the device data from the other electronic device based on the identification data stored in the storage unit.

11. The electronic device as claimed in claim 1, wherein the obtaining unit is configured to obtain at least one of encoded device data and compressed device data from the target electronic device.

12. A data processing system comprising:
an electronic device; and
at least another electronic device connected to the electronic device;
wherein the electronic device includes
a reception unit configured to receive an obtaining command and
an obtaining unit configured to obtain device data retained in at least one of the electronic device and the other electronic device;
wherein the device data includes log data indicating a process performed by at least one of the electronic device and the other electronic device, scan data indicating data scanned by at least one of the electronic device or the other electronic device, and setting data indicating data set to at least one of the electronic device and the other electronic device by a user;
wherein the device data obtained by the obtaining unit includes at least the scan data and the setting data.

13. A computer-readable recording medium on which a program is recorded for causing an electronic device connected to at least another electronic device to execute a data processing method, the data processing method comprising the steps of:
receiving an obtaining command;
obtaining device data retained in at least one of the electronic device and the other electronic device;
wherein the device data includes log data indicating a process performed by at least one of the electronic device and the other electronic device, scan data indicating data scanned by at least one of the electronic device or the other electronic device, and setting data indicating data set to at least one of the electronic device and the other electronic device by a user;
wherein the device data obtained by the obtaining unit includes at least the scan data and the setting data.
